(19) United States
(12) Patent Application Publication
(10) Pub. No.: US 2013/0325549 A1
(43) Pub. Date: Dec. 5, 2013

(54) RECALL AND MARKET WITHDRAWAL ANALYSIS

(71) Applicants: Laurie Kristine Murphy, Otsego, MN (US); Lisa Kaye Hohn, Lexington, MN (US); Kimberly Jo Moore, Woodbury, MN (US)

(72) Inventors: Laurie Kristine Murphy, Otsego, MN (US); Lisa Kaye Hohn, Lexington, MN (US); Kimberly Jo Moore, Woodbury, MN (US)

(73) Assignee: TARGET BRANDS, INC., Minneapolis, MN (US)

(21) Appl. No.: 13/485,345

(22) Filed: May 31, 2012

(51) Int. Cl. G06Q 10/04; G06Q 30/02

(52) U.S. Cl. 705/7.31

(57) ABSTRACT

A computer system captures inventory data from an inventory management system on a recurring basis. The computer system stores the inventory data in a database that is separate from the inventory management system. The computer system determines, based at least in part on the inventory data stored in the database, an estimated financial impact to a retailer of recalling a merchandise type or withdrawing the merchandise type from market. After determining the estimated financial impact, the computer system outputs a report that indicates the estimated financial impact.

### BACKGROUND

Retailers include entities that sell merchandise. For example, a retailer may be a business that retails general merchandise to consumers. In another example, a retailer may be a business that wholesales merchandise to other businesses.

For various reasons, a retailer may need to perform a recall or market withdrawal for a particular type of merchandise (i.e., a particular merchandise type) that the retailer is selling. For example, the retailer may need to perform a recall or a market withdrawal for the merchandise type if the merchandise type is not safe, has poor quality, does not comply with governmental regulations, has been recalled by a manufacturer or distributor of the merchandise type, or otherwise.

When a retailer recalls a type of merchandise (i.e., a merchandise type), the retailer may stop selling the merchandise type and may notify the retailer's customers to return or stop using items belonging to the merchandise type. The retailer may perform a recall in conjunction with a government agency. Recalls may involve food safety or product safety issues. When a retailer withdraws a merchandise type from market (i.e., performs a market withdrawal for the merchandise type), the retailer may stop selling the merchandise type, but does not necessarily notify the retailer's customers to return or stop using items belonging to the merchandise type.

### SUMMARY

In general, a computer system facilitates analysis of recalls and market withdrawals of merchandise sold by a retailer at one more locations, e.g. one or more retail outlet stores. In one example, the computer system captures inventory data from an inventory management system on a recurring basis. The computer system stores the inventory data in a database that is separate from the inventory management system. The computer system determines, based at least in part on the inventory data stored in the database, an estimated financial impact to the retailer of recalling a type of merchandise or withdrawing the type of merchandise from market. The computer system outputs a report that indicates the estimated financial impact.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram that illustrates an example environment in which the techniques of this disclosure may be implemented.

FIG. 2 is a block diagram that illustrates an example configuration of a recall system.

FIG. 3 is a flowchart that illustrates an example inventory capture operation performed by the recall system.

FIG. 4 is a flowchart that illustrates an example report generation operation performed by the recall system.

FIG. 5 is a conceptual diagram that illustrates an example vendor summary report and an example hazard report generated by the recall system.

FIG. 6 is a conceptual diagram that illustrates an example vendor incident report generated by the recall system.

FIG. 7 is a conceptual diagram that illustrates an example vendors-by-division report generated by the recall system.

FIG. 8 is a conceptual diagram that illustrates an example analyst summary report generated by the recall system.

FIG. 9 is a conceptual diagram that illustrates an example analyst detail report generated by the recall system.

FIG. 10 is a conceptual diagram that illustrates an example analyst pending incidents report generated by the recall system.

FIG. 11 is a conceptual diagram that illustrates an example product detail report generated by the recall system.

FIG. 12 is a conceptual diagram that illustrates an example product detail by division report generated by the recall system.

FIG. 13 is a block diagram that illustrates an example configuration of a computer system.

### DETAILED DESCRIPTION

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Furthermore, stacked elements in the attached drawings indicate the presence of one or more similar elements. In this disclosure, elements having names that start with ordinal words (e.g., “first,” “second,” “third,” and so on) do not necessarily imply that the elements have a particular order. Rather, such ordinal words are merely used to refer to different elements of a same or similar type.

As described below, a computer system generates reports that contain information regarding recalls or market withdrawals of merchandise. When a retailer recalls a type of merchandise (i.e., a merchandise type), the retailer may stop selling the merchandise type and may notify the retailer's customers to return or stop using items belonging to the merchandise type. The retailer may perform a recall in conjunction with a government agency. Recalls may involve food safety or product safety issues. When a retailer withdraws a merchandise type from market (i.e., performs a market withdrawal for the merchandise type), the retailer may stop selling the merchandise type, but does not necessarily notify the retailer's customers to return or stop using items belonging to the merchandise type.

To generate such reports, the computer system captures, on a recurring basis, inventory data from an inventory management system of a retailer. The inventory data may be associated with monetary values of items belonging to the merchandise type in an inventory of the retailer. For instance, the inventory data may indicate the monetary value of the items. In other instances, the inventory data may be associated with the monetary values of the items in that the monetary values of the items may be determined at least in part from the inventory data. The computer system may store the captured inventory data in a database separate from the inventory management system. In some examples, the database may be separate from the inventory management system in that the database is stored on physical computer-readable storage media that are not used by the inventory management system. In other examples, the database may be separate from the inventory management system in that the inventory management system does not write data to the database.

The computer system may determine, based at least in part on the captured inventory data stored in the database, an estimated financial impact of performing a recall or market withdrawal of a merchandise type. The computer system may then generate one or more reports that indicate the estimated financial impact. In some examples, the retailer may be able to determine, based on such reports, whether to perform a recall or a market withdrawal of the merchandise type. Furthermore, in some examples, such reports may include information about recalls or market withdrawals associated with various employees of the retailer, divisions or departments of the retailer, suppliers of the retailer, and so on.

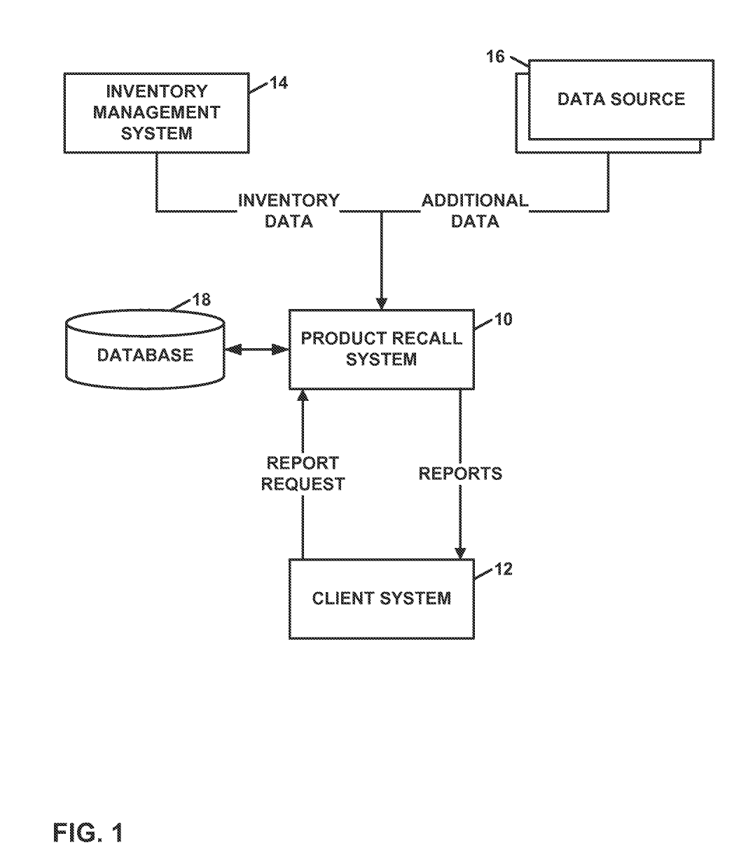

FIG. 1 is a block diagram that illustrates an example environment in which the techniques of this disclosure may be implemented. As illustrated in the example of FIG. 1, the environment includes a recall system 10, a client system 12, an inventory management system 14, a plurality of data sources 16, and a database 18. In other examples, the environment may include more, fewer, or different systems or components.

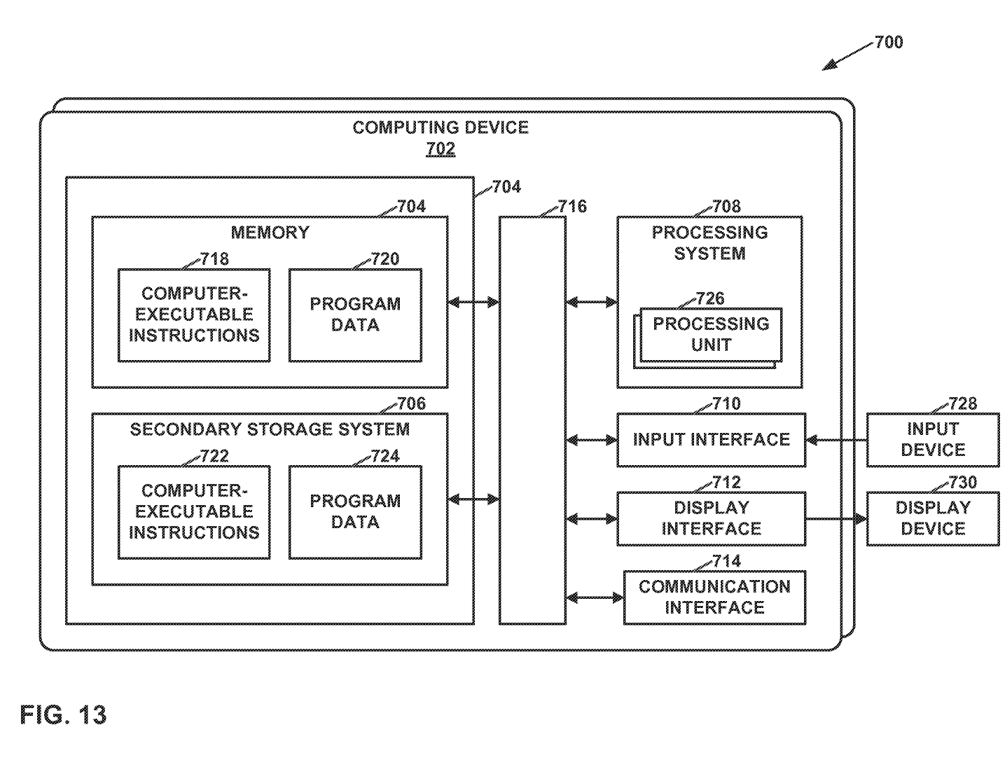

Recall system 10, client system 12, inventory management system 14, and data sources 16 may be implemented in various ways. For example, recall system 10, client system 12, inventory management system 14, and data sources 16 may be implemented as one or more software systems executed by one or more computing devices. FIG. 13, described in detail below, illustrates an example computer system that may execute a software system to implement recall system 10, client system 12, inventory management system 14, and/or data sources 16. Example types of computing devices include personal computers, laptop computers, mainframe computers, tablet computers, server computers, smartphones, workstation computers, and other types of physical computing devices. In other examples, recall system 10, client system 12, inventory management system 14, and/or data sources 16 may be implemented as least in part using computing devices that have hardware specifically designed to implement recall system 10, client system 12, inventory management system 14, and/or data sources 16.

Database 18 may be implemented in various ways. For example, database 18 may be implemented as one or more relational databases, file systems, flat files, associative databases, object-oriented databases, or other types of data structures.

Recall system 10 is able to communicate with client system 12, inventory management system 14, and data sources 16. Recall system 10 may be able to communicate with client system 12, inventory management system 14, and data sources 16 in various ways. For example, recall system 10 may be able to communicate with client system 12, inventory management system 14, and data sources 16 via one or more communication networks, such as local area networks (LANs), virtual private networks, or the Internet.

Inventory management system 14 stores data regarding a retailer's inventory. In some examples, the retailer may be an entity that retails merchandise through physical, tangible, non-Internet-based retail stores. The retailer's inventory may include merchandise on hand, merchandise on withdrawal, merchandise owned on order, and so on. Merchandise on hand may include merchandise that is physically available in one location (such as a physical, tangible, non-Internet-based retail stores) for selling. For instance, merchandise on hand may include merchandise on store shelves in aisles of retail stores and in the stockrooms of retail stores. Merchandise on withdrawal may include merchandise that is en route from a distribution center to a physical, tangible, non-Internet-based retail store. Merchandise owned on order may include merchandise owned by the retailer and in transit between facilities for replenishment of the merchandise at one of the facilities. In general, merchandise includes goods to be sold by the retailer.

The data in inventory management system 14 may change relatively quickly. For example, the data in inventory management system 14 may change when merchandise is sold by the retailer. In another example, the data in inventory management system 14 may change when the retailer accepts delivery of merchandise from a supplier. In general, suppliers include entities, such as other retailers, from which the retailer receives merchandise. This disclosure may also refer to suppliers as “vendors.” In another example, the data in inventory management system 14 may change when merchandise changes among merchandise on hand, merchandise on withdrawal, and merchandise owned on order.

In some examples, the data in inventory management system 14 may be updated on a recurring basis. For example, the data in inventory management system 14 may be updated once per time interval. For instance, the data in inventory management system 14 may be updated at least once per hour (e.g., once per fifteen minutes). In this example, the data in inventory management system 14 may be updated to reflect changes in the retailer's inventory occurring during the previous time interval.

Recall system 10 may capture sets of inventory data from inventory management system 14 on a recurring basis. In general, recall system 10 captures sets of inventory data from inventory management system 14 on a recurring basis that is less frequent than the recurring basis on which inventory data in inventory management system 14 is updated. In other words, the recurring basis on which inventory data of inventory management system 14 is updated may be more frequent than the recurring basis on which recall system 10 captures inventory data from inventory management system. For example, recall system 10 may capture a set of inventory data from inventory management system 14 whenever a time period of a defined duration elapses. For instance, recall system 10 may capture sets of inventory data from inventory management system 14 once every day (i.e., once per twenty-four hours). In other examples, recall system 10 may capture inventory data from inventory management system 10 when time durations of other lengths elapse. For instance, recall system 10 may capture sets of inventory data from inventory management system 10 whenever 48, 12, or 6 hour time periods elapse. In some examples, multiple time periods between recall system 10 capturing sets of inventory data from inventory management system are not necessarily equal. In other examples, recall system 10 may capture sets of inventory data from inventory management system 14 in response to various other events occurring, e.g. user input, events triggered by software programs, etc.

When recall system 10 captures sets of inventory data from inventory management system 14, recall system 10 may obtain sets of the inventory data from inventory management system 14 and store sets of the inventory data in database 18. Database 18 may be separate from inventory management system 14. To ensure that the sets of inventory data captured from the inventory management system 14 are logically coherent, recall system 10 may prevent inventory management system 14 from updating the inventory data while recall system 10 is obtaining a set of inventory data from inventory management system 14. In some examples, recall system 10 may use transaction-commit semantics to freeze the inventory data of inventory management system 14 while recall system 10 is obtaining a set of inventory data from inventory management system 14. In this way, when recall system 10 captures a set of inventory data from inventory management system 14, recall system 10 captures a “snapshot” of the inventory data in inventory management system 14 at a particular moment in time.

Because storage space in database 18 may be limited, recall system 10 may purge old inventory data from database 18. For example, recall system 10 may purge a set of inventory data from database 18 if the inventory data was stored in database 18 more than one year prior to the current date. Thus, if recall system 10 captures inventory data from inventory management system 14 once per day, database 18 may contain up to 365 (366 during leap years) “snapshots” of the inventory data.

Recall system 10 may obtain sets of inventory data from inventory management system 14 in various ways. For example, recall system 10 may issue a query, such as a SQL query, to inventory management system 14. In another example, inventory management system 14 may implement an application programming interface (API) containing one or more operations that recall system 10 may invoke to obtain the sets of inventory data from inventory management system 14. In another example, inventory management system 14 may implement a web server that sends the inventory data to recall system 10 in response to web services requests, such as hypertext transfer protocol (HTTP) requests.

Recall system 10 may receive report requests from client system 12. In response to receiving a report request from client system 12, recall system 10 may generate a report and output the report. The report may include data regarding recalls and market withdrawals associated with the retailer. For example, the report may indicate recalls or market withdrawals of merchandise types associated with a division or department of the retailer. In another example, the report may indicate recalls or market withdrawals associated with an analyst.

A report may present the data in various ways. For example, a report may include data presented as a table. In other examples, reports may include data presented as pie charts, bar graphs, trend graphs, text, or otherwise.

In some examples, the data in a report may include an estimated financial impact of performing a recall or market withdrawal of one or more types of merchandise in the inventory of the retailer. The estimated financial impact of performing a recall or market withdrawal of a merchandise type may provide an approximation of a current liability of the retailer if the retailer performed a recall or market withdrawal of the merchandise type. The estimated financial impact of performing a recall or market withdrawal of a merchandise type may be indicated in currency, such as U.S. dollars. The estimated financial impact may assist the retailer in evaluating the relative impact of the recall or market withdrawal on the retailer's business and may, in this manner, assist the retailer in making various decisions related to such recall or market withdrawal.

Recall system 10 may determine, based at least in part on the inventory data stored in database 18, the estimated financial impact of recalling or withdrawing from market the type of merchandise. Recall system 10 may determine the estimated financial impact of performing a recall or market withdrawal based on inventory data in database 18 instead of inventory data in inventory management system 14 because the inventory data in inventory management system 14 may reflect a current inventory of the retailer, not a historical inventory of the retailer. Because inventory management system 14 may not store historical inventory data of the retailer, recall system 10 may be unable to determine an estimated financial impact based on inventory data stored by inventory management system 14. In other words, inventory management system 14 may be configured to track and reflect current merchandise inventories and may therefore be in a constant state of changing inventory levels as merchandise is sold or otherwise removed from or added to inventory. Thus, recall system 10 is configured to capture and store inventory data so that recall system 10 may determine amount of inventory and the financial costs associated therewith in the event of a recall or market withdrawal of a particular merchandise type.

Recall system 10 may determine the estimated financial impact in various ways. For example, recall system 10 may determine the estimated financial impact based on a number of difference inventory metrics related to the merchandise type that is stored in inventory management system 14 and periodically captured by recall system 10. Recall system 10 may employ some combination of such inventory metrics to approximate the number of units of the merchandise implicated in a recall or market withdrawal. In one example, recall system 10 may determine the estimated financial impact based on an ending-on-hand value for the merchandise type, an on-order value for the merchandise type, an owned-on-order value for the merchandise type, and an on-withdrawal value for the merchandise type. Recall system 10 may use captured inventory data in database 18 to determine the ending-on-hand value, the on-order value, the owned-on-order value, and the on-withdrawal value. In some examples, recall system 10 may determine the estimated financial impact of performing a recall or market withdrawal of the merchandise type by adding together the ending-on-hand value for the merchandise type, the on-order value for the merchandise type, the owned-on-order value for the merchandise type, and the on-withdrawal value for the merchandise type. In some such examples, if any of the ending-on-hand, on-order, owned-on-order, or on-withdrawal values are negative, recall system 10 replaces the value with zero. For instance, if the ending-on-hand value is equal to −5, recall system 10 uses zero as the ending-on-hand value when determining the estimated financial impact.

The ending-on-hand value may indicate a monetary value of the retailer's inventory of items of the merchandise type at the end of a period. The period may be selected by a user of recall system 10. For instance, the period may be a most recent week, month, etc. Recall system 10 may determine the ending-on-hand value for the merchandise type based on a beginning-on-hand value for the merchandise type, a total receipts value for the merchandise type, a total sales value for the merchandise type, a shortage value for the merchandise type, an employee discount value for the merchandise type, a total markdown value for the merchandise type, and a return-to-vendor value for the merchandise type. The beginning-on-hand value for the merchandise type may indicate the monetary value of items belonging to the merchandise type at the beginning of the period. The total sales value for the merchandise type may indicate a monetary value of items belonging to the merchandise type that the retailer sold during the period. The total receipt value for the merchandise type may indicate a monetary value of items of the merchandise type that have been received by the retailer. The shortage value for the merchandise type may indicate a monetary value of items belonging to the merchandise type lost or stolen during the period. The employee discount value of the merchandise type may indicate a monetary value of employee discounts associated with sales of the merchandise type. The total markdown value of the merchandise type may indicate a total monetary value of markdowns associated with sales of the merchandise type. The return-to-vendor value of the merchandise type may indicate a monetary value of items belonging to the merchandise type returned to the vendor of the merchandise type during the period.

Recall system 10 may use captured inventory data in database 18 to determine the beginning-on-hand value, the total receipt value, the total sales value, the shortage value, the employee discount value, the total markdown value and the return-to-vendor value. In some examples, recall system 10 may determine the ending-on-hand value by adding the beginning-on-hand value to the total receipts value and subtracting the total sales value, the shortage value, the employee discount value, the total markdown value, and the return-to-vendor value.

The on-order value for the merchandise type may indicate the monetary value of items belonging to the merchandise type that the retailer has ordered from a vendor of the merchandise type, but not yet received. Recall system 10 may determine the on-order value for the merchandise type at various levels, such as an item level, a merchandise subclass level, a merchandise class level, or a department level. The owned-on-order value for the merchandise type may indicate the monetary value of items belonging to the merchandise type that are owned by the retailer and are in transit between two of the retailer's or another party's facilities for replenishment of one of the retailer's facilities. The on-withdrawal value for the merchandise type may indicate the monetary value of items belonging to the merchandise type that are en route from a distribution center of the retailer to a store of the retailer as part of a distribution center invoice (DCI) process. A DCI may also be referred to as a packing slip.

Recall system 10 may also obtain data from data sources 16. Recall system 10 may generate recall report data based on the data obtained from data sources 16. In other words, recall system 10 may use data obtained from data sources 16 to generate recall report data. For example, one of data sources 16 may include an order management system. In this example, the order management system may store details about orders that the retailer places with suppliers. In this example, recall system 10 may use data from the order management system to generate data for reports indicating orders for merchandise types associated with a recall or market withdrawal.

In some examples, recall system 10 may generate reports that associate the data received from one or more of data sources 16 with the estimated financial impacts of performing a recall or market withdrawal of one or more merchandise types. For instance, the additional data obtained from data sources 16 may relate to a vendor that supplies a merchandise type to the retailer. In this example, a report may associate the data about the vendor with the estimated financial impact of performing a recall or market withdrawal of the merchandise type. In this way, recall system 10 may generate reports that indicate recalls or market withdrawals of merchandise types associated with estimated financial impacts of the merchandise types and vendors that supply the merchandise types to the retailer.

Recall system 10 may obtain data from data sources 16 in response to various events. For example, recall system 10 may obtain data from one or more of data sources 16 in response to receiving a request for a report. In some examples, recall system 10 may obtain data from one or more of data sources 16 on a recurring basis, such as a periodic basis. For instance, recall system 10 may obtain data from one or more of data sources 16 once per 24-hour period.

Recall system 10 may obtain data from data sources 16 in various ways. For example, recall system 10 may issue a query, such as a SQL query, to one or more of data sources 16. In another example, one or more of data sources 16 may implement APIs containing operations that recall system 10 may invoke to obtain the data. In another example, one or more of data sources 16 may implement web servers that send the data to recall system 10 in response to web services requests, such as HTTP requests.

Data sources 16 may include a business partner management (BPM) system, a field assessment tool (FAS-T), host legal tables, an item system, an order management system, a sales recording system, a risk management information system (RMIS). The BPM system may provide information about the retailer's business partners. For example, a business partner may be responsible for or have relationships with multiple vendors of the retailer. In this example, the BPM system may provide maps of relationships from vendors to business partners.

The host legal tables may provide information about a merchandise structure and how the merchandise structure maps back to the retailer's organizational buying structure. For instance, the host legal tables may provide information about which merchandise is purchased by various groups of divisions, divisions, and departments of the retailer.

The item system may provide information about attributes of items. Example attributes of items include color, size, material, dimensions, and so on.

The order management system may provide information related to a process of ordering merchandise from vendors. The information provided by the order management system may include purchase orders, quantities, shipment dates, and other information about the process of ordering merchandise from vendors. The sales recording system may provide information about recorded sales of merchandise.

The FAS-T is an application for collection of incident-related data from persons working for the retailer. The RMIS may provide information about incidents, such as recalls, market withdrawals, and track-and-trend events. The RMIS may store such data for multiple years. As such, in one example, the RMIS may store data regarding recalls and market withdrawals, associated with various other data such as departments or personnel, for past time periods, which recall system 10 may employ to compare to current recall and/or market withdrawal data. Data sources 16 may be separate from inventory management system 10 in that data sources 16 may be implemented using separate software systems or physical computer hardware.

After recall system 10 generates a report, recall system 10 may output the report. Recall system 10 may output the report in various ways. For example, recall system 10 may output the report by transmitting data representing the report to client system 12 via a communication network. In another example, recall system 10 may write data representing the report to a physical computer-readable storage medium, such as an optical disc, a floppy disk, a solid-state memory device (e.g., a thumb drive), and so on. In another example, recall system 10 may output the report by printing the report to paper. In another example, recall system 10 may output the report on a display screen.

The data representing the report may include data formatted in various ways. For example, the data representing the report may include Hypertext Markup Language (HTML), extensible markup language (XML), a word processor document, a spreadsheet document, comma separated values (CSV) formatted data, portable document format (PDF), and/or data formatted in other ways.

Upon receiving the report from recall system 10, client system 12 may present the report. Client system 12 may present the report in various ways. For example, client system 12 may display the report in a web browser application. In another example, client device 12 may display the report in a special-purpose application, such as a spreadsheet application, a word processor application, a database access application, or another type of application.

In this way, a computer system that implements recall system 10 may obtain, on a recurring basis, sets of inventory data from inventory management system 14. The sets of inventory data may indicate monetary values of a merchandise type in an inventory of a retailer at different times. The computer system may store the sets of inventory data in a database separate from the inventory management system. In addition, the computer system may determine, based at least in part on the sets of inventory data stored in the database, an estimated financial impact to the retailer of performing a recall or market withdrawal of the merchandise type. The computer system may output a report that indicates the estimated financial impact, including outputting the estimated financial impact and recall or market withdrawal associated therewith in a report with various other parameters.

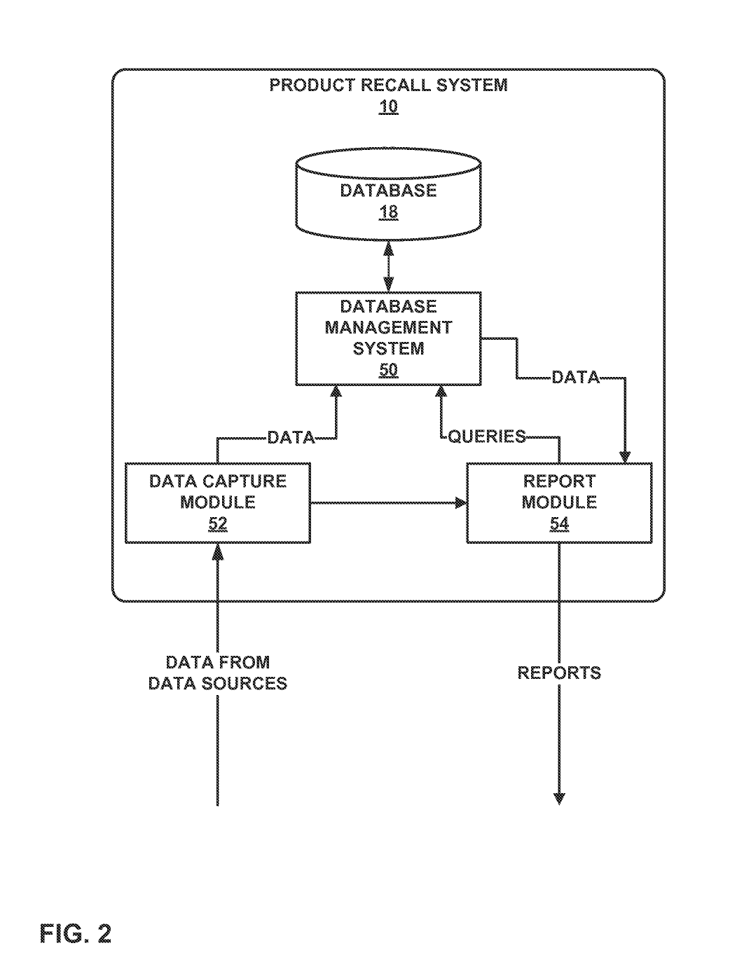

FIG. 2 is a block diagram that illustrates an example configuration of recall system 10. In the example of FIG. 2, recall system 10 includes database 18, a database management system 50, a data capture module 52, and a report module 54. In other examples, recall system 10 may include more, fewer, or different components. Recall system 10, including the particular components and modules illustrated in the example of FIG. 2, may be implemented in software, hardware, or a combination of both software and hardware components. Various components of recall system 10 may be implemented in a single computing device or may be distributed across multiple computing devices collocated or communicatively connected between a number of locations.

Database management system 50 manages database 18. For instance, database management system 50 stores data into database 18 and retrieves data from database 18 in response to queries received by database management system 50.

Data capture module 52 may capture sets of inventory data from inventory management system 14. Each set of inventory data may indicate monetary values of one or more merchandise types in an inventory of the retailer. In some examples, the sets of inventory data may include other types of data, such as quantities of the merchandise types in the inventory of the retailer. In some examples, the inventory data may indicate departments, classes of merchandise, and item identifiers associated with particular merchandise types within a class. Furthermore, in some examples, the inventory data may include quantities and/or monetary values of items on hand for the retailer, items on hand at distribution centers of the retailer, items on hand at stores of the retailer, and so on. The inventory data may also indicate quantities and/or monetary values of items on order at a retailer level, at a distribution center level, or at an individual store level. Data capture module 52 may then provide the sets of inventory data to database management system 50. In response to receiving a set of inventory data, database management system 50 may store the set of inventory data in database 18.

Data capture module 52 may capture sets of inventory data from inventory management system 14 on a recurring basis. For example, data capture module 52 may capture a set of inventory data from inventory management system 14 once per time period (e.g., 24 hours). In another example, data capture module 52 may capture a set of inventory data from inventory management system 14 in response to particular events.

In addition, data capture module 52 may receive additional data from data sources 16. In some examples, data capture module 52 may provide some or all of the additional data to database management system 50 for storage in database 18. In other examples, data capture module 52 does not provide the additional data to database management system 50 for storage in database 18. Rather, data capture module 52 may provide such data to report module 54.

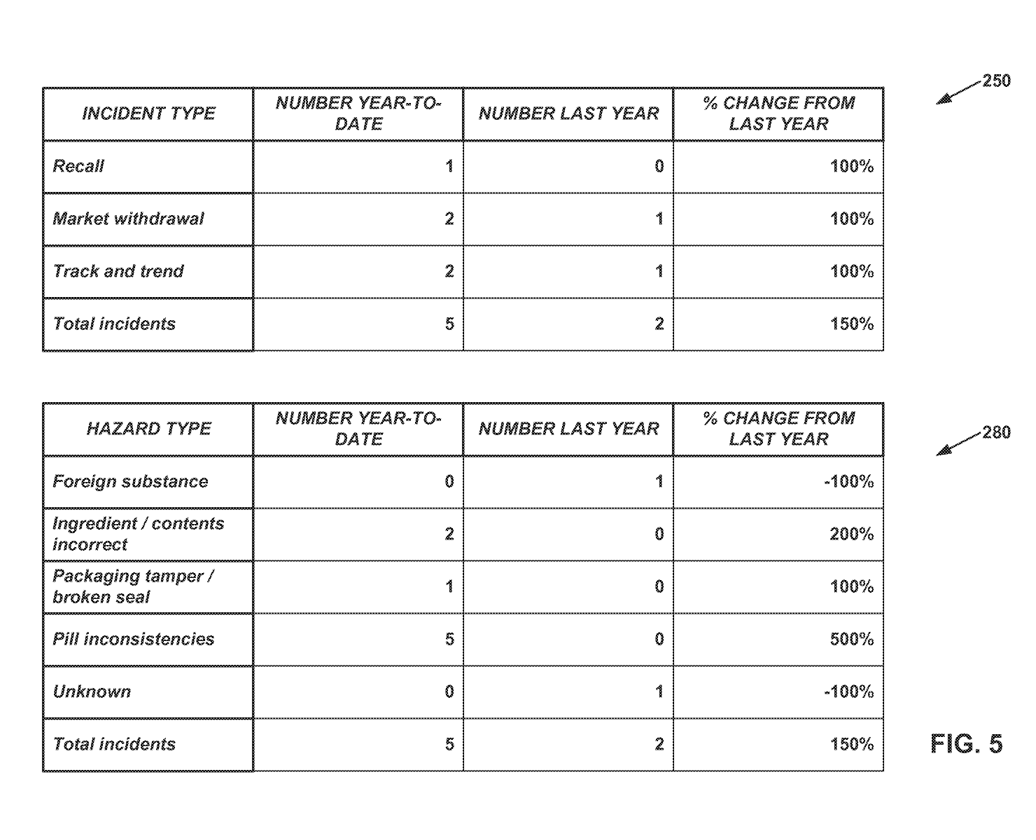

Report module 54 may use inventory data stored in database 18 and/or additional data obtained from data sources 16 to generate reports. After generating a report, report module 54 may output the report. The retailer may use such reports to discover information about actual or potential recalls or market withdrawals associated with the retailer. Report module 54 may generate various types of reports. FIGS. 5-12, described below, illustrate example reports that report module 54 may generate. Report module 54 may generate reports that are different than the example reports illustrated in FIGS. 5-12.

To generate particular reports, report module 54 may determine estimated financial impacts of a recall or market withdrawal of one or more merchandise types. The reports generated by report module 54 may include the estimated financial impacts. In some examples, report module 54 may also generate reports that do not include estimated financial impacts.

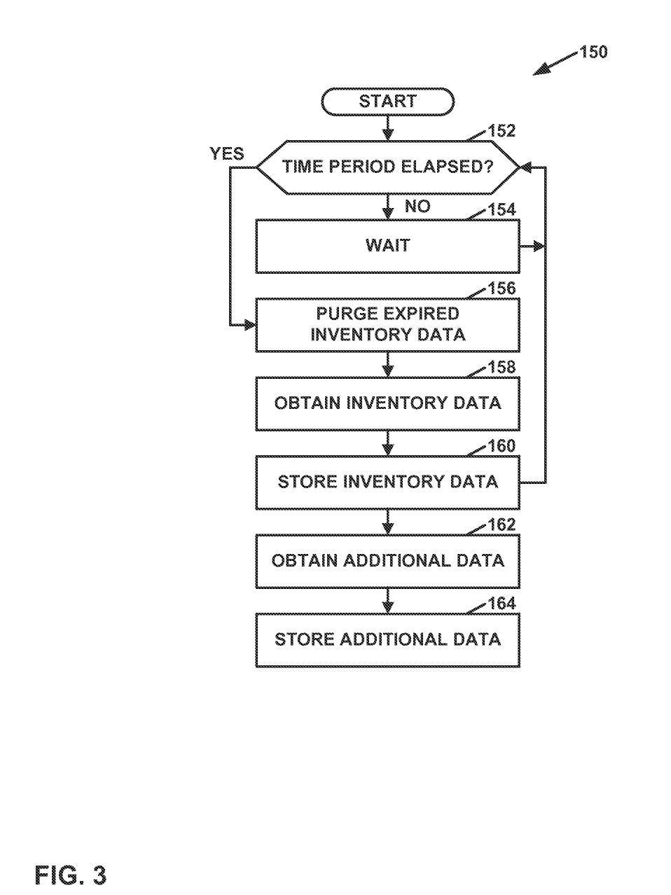

FIG. 3 is a flowchart that illustrates an example inventory capture operation 150 performed by recall system 10. After recall system 10 starts inventory capture operation 150, data capture module 52 (FIG. 2) may determine whether a time period has elapsed (152). In various examples, data capture module 52 may determine whether various time periods have elapsed. For example, data capture module 52 may determine whether a 24-hour period has elapsed. If the time period has not elapsed (“NO” of 152), data capture module 52 may wait for the time period to elapse (154).

However, in response to determining that the time period has elapsed (“YES” of 152), data capture module 52 may purge expired inventory data from database 18 (156). The expired data may include data that was not added to database 18 within a rolling time window. For example, the length of the time window may be 365 days prior to the current date. In this example, data capture module 52 may purge data from database 18 if recall system 10 added the data to database 18 more than 365 days prior to the current date. In this way, the computer system that implements recall system 10 may purge expired sets of inventory data from database 18, the expired sets of inventory data having been stored in the database for longer than an expiration period.

In some examples, data capture module 52 may delete the expired data from database 18 when data capture module 52 purges the expired data from database 18. In other examples, data capture module 52 may allow the expired data to be overwritten when data capture module 52 purges the expired data from database 18.

Furthermore, after determining that the time period has elapsed, data capture module 52 may obtain a set of inventory data from inventory management system 14 (158). After obtaining the set of inventory data from inventory management system 14, data capture module 52 may store the set of inventory data in database 18 (160). In some examples, data capture module 52 may also obtain additional data from data sources 16 (162). Data capture module 52 may store the additional data in database 18 (164).

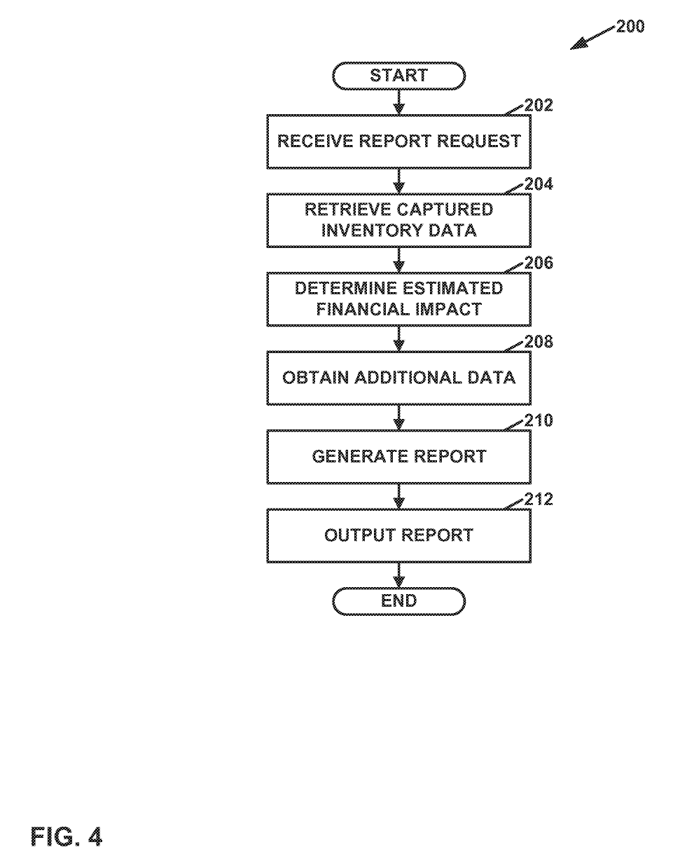

FIG. 4 is a flowchart that illustrates an example report generation operation 200 performed by recall system 10. After recall system 10 starts report generation operation 200, report module 54 may receive a report request from client system 12 (202). Report module 54 may receive the report request in various ways. For example, report module 54 may implement a web server that receives the report request as a web services request. In this example, report module 54 may provide a launch page to client system 12. The launch page may be a web page that includes data entry fields. A user of client system 12 may input criteria into data entry fields. The criteria may indicate a type of report that the user wants to view. In another example, report module 54 may implement an API that receives the report request as an invocation of a method in the API. In other examples, report module 54 may receive the report request from a user interface presented by a computer system on which recall system 10 is running.

Report module 54 may receive requests for various types of reports. For example, report module 54 may receive a request for a product report that includes information about merchandise types. In another example, report module 54 may receive a request for an analyst report that includes information about analyst workload and/or productivity with reference to recalls and/or market withdrawals being handled by each analyst of the retailer. In another example, report module 54 may receive a request for a vendor report that includes information about one or more vendors and merchandise recalls and market withdrawals associated with each vendor. For instance, in this example, report module 54 may receive a request for a vendor detail report that shows information about a single vendor. In other instances, report module 54 may receive a request for reports that show information about vendors by division, department, or other subgroup of the retailer. The request for a vendor report may include a date rate.

To assist the user in selecting a report, particular data entry fields of a launch page may be enabled or disabled based on data entered into other data entry fields. For example, the launch page may include data entry fields for groups of divisions, division, department, analyst, and action taken. A division may be a group of departments. Each department may be associated with a particular category or categories of merchandise. In this example, these data entry fields may be disabled if the user selects a vendor detail report. In another example, the launch page may include data entry fields for analysts and actions taken. In this example, these data entry fields may be disabled if the user selects a report to view information about a vendor by pyramid, division, or department.

In response to receiving the report request, report module 54 may retrieve captured inventory data from database 18 (204). After retrieving the captured inventory data, report module 54 may determine, based on the captured inventory data, estimated financial impacts of a recall or a market withdrawal of one or more merchandise types (206). As described above, report module 54 may determine the estimated financial impact of a recall or market withdrawal of a merchandise type based on an ending-on-hand value for the merchandise type, an on-order value for the merchandise type, an owned-on-order value for the merchandise type, and an on-withdrawal value for the merchandise type.

Some reports generated by report module 54 do not indicate estimated financial impacts. In some examples, report module 54 does not retrieve captured inventory data or determine the estimated financial impacts of recalling the merchandise in response to receiving requests for such reports.

In addition to retrieving the captured inventory data and determining the estimated financial impact of recalling the merchandise, report module 54 may obtain additional data from one or more of data sources 16 (208). In some examples, report module 54 may have obtained the additional data prior to receiving the report request. After obtaining the additional data, report module 54 may use the estimated financial impacts and the additional data to generate a report (210). Report module 54 may then output the report (212).

FIG. 5 is a conceptual diagram that illustrates an example vendor summary report 250 and an example hazard report 280 generated by recall system 10. The retailer may use vendor summary report 250 to analyze the general performance of a vendor that supplies one or more types of merchandise to the retailer. The retailer may use hazard report 280 to analyze the types of hazards, if any, that prompted recall events associated with the vendor.

Vendor summary report 250 includes a set of rows and a set of columns. A first row corresponds to recalls associated with the vendor. A second row corresponds to market withdrawals associated with the vendor. A third row corresponds to track-and-trend events associated with the vendor. A track-and-trend event may occur when the retailer is tracking a pattern of events associated with a merchandise type to determine whether to perform a recall or a market withdrawal of the merchandise type. For instance, when a track-and-trend event occurs, the retailer may monitor a product for a pattern of safety issues or non-compliance and may escalate an investigation of the merchandise type if a pattern is identified. For example, the retailer may perform a recall or market withdrawal if a pattern is identified in the track-and-trend event. A fourth row corresponds to total numbers of incidents associated with the vendor. An incident may refer to a recall, a market withdrawal, or a track-and-trend event. In this disclosure, an incident may also be referred to as an “issue.”

A first column of vendor summary report 250 corresponds to types of incidents associated with the vendor. A second column corresponds to total numbers of each type of incident for the vendor to-date this year. A third column corresponds to total number of each type of incident for the vendor last year. A fourth column corresponds to percent changes of each type of recall event for the vendor from last year to this year. In another example, different time periods may be employed to track incidents and to compare current incident levels to past levels. For example, instead of tracking different types of incidents for a particular vendor over on an annual basis as illustrated in example report 250 of FIG. 5, a different report in accordance with this disclosure may track incidents for the vendor on a biannual basis.

Hazard report 280 includes a set of rows and a set of columns. The rows correspond to different types of hazards that the retailer has associated with merchandise types provided by the vendor. Each of the columns corresponds to different types of information associated with a type of hazard. A first column corresponds to a name of the type of hazard. A second column corresponds to a number of incidents prompted by the type of hazard to-date this year. A third column corresponds to a number of incidents prompted by the type of hazard last year. A fourth column corresponds to a percent change in the number of incidents of the type of hazard from last year to this year.

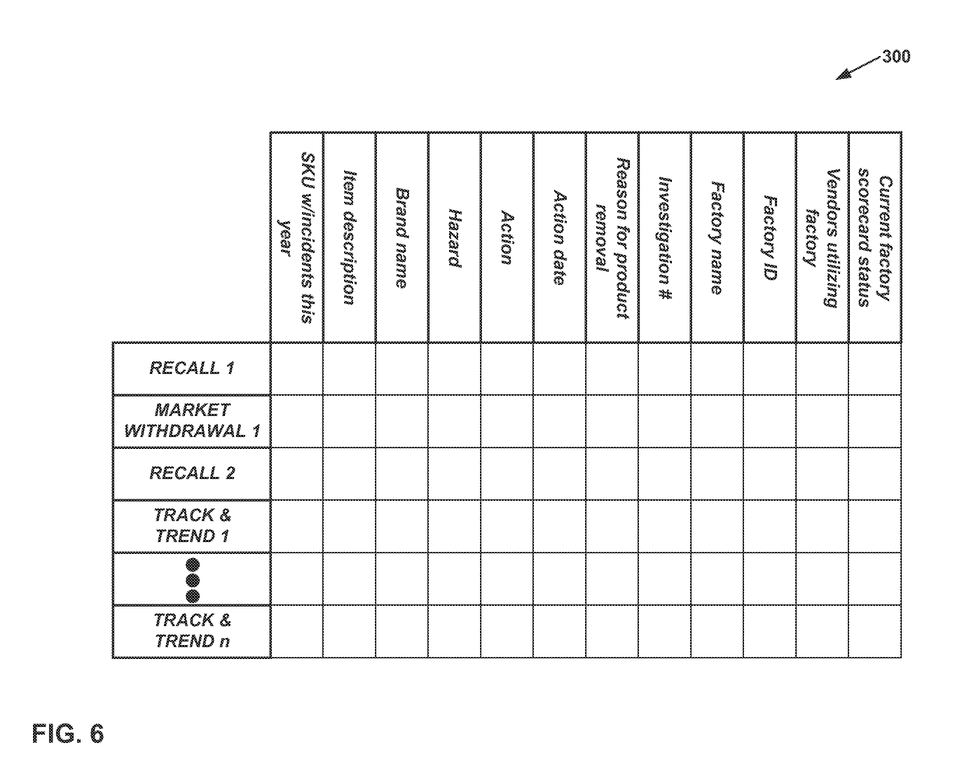

Recall system 10 may generate reports 250 and 280 of FIG. 5 and output the reports in various ways, including, e.g., transmitting data representing the reports to client system 12 via a communication network, writing data representing the reports to a physical computer-readable storage medium, printing the report to paper, or outputting the reports on a display screen. The data representing reports 250 and 280 may include data formatted in various ways. For example, the data representing reports 250 and 280 may include Hypertext Markup Language (HTML), extensible markup language (XML), a word processor document, a spreadsheet document, comma separated values (CSV) formatted data, portable document format (PDF), and/or data formatted in other ways. Recall system 10 may generate and output the reports described below with reference to FIGS. 6-12 in a similar manner as described with reference to reports 250 and 280 of FIG. 5.

FIG. 6 is a conceptual diagram that illustrates an example vendor incident report 300 generated by recall system 10. The retailer may use vendor incident report 300 to analyze incidents associated with a vendor.

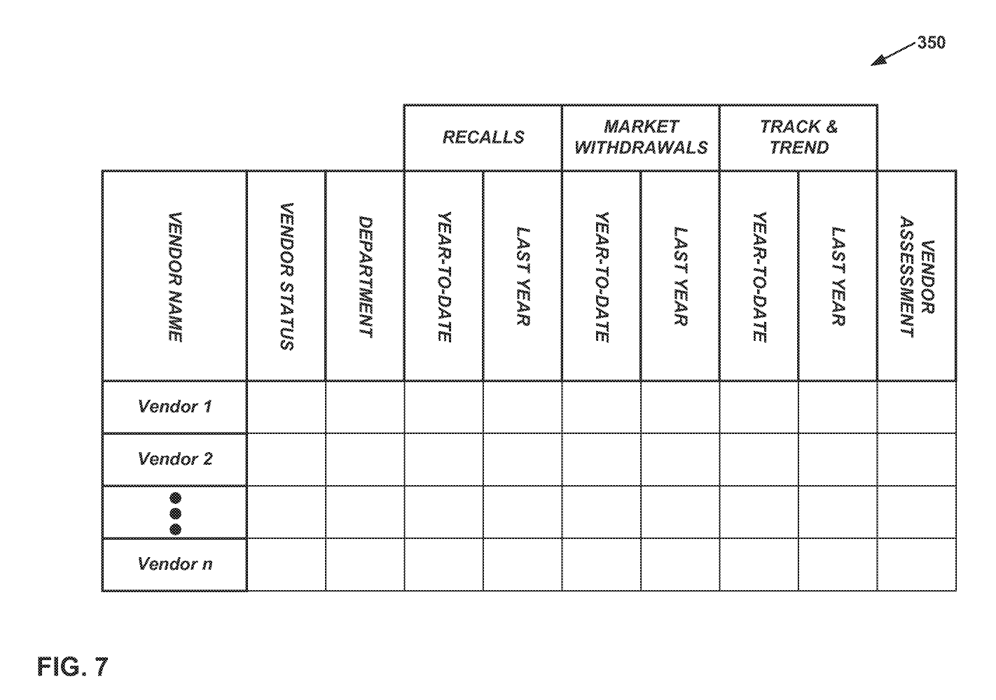

Vendor incident report 300 includes a set of rows and a set of columns. In the view of FIG. 6, “rows” are arranged from the left of report 300 to the right and “columns” appear from the top of report 300 to the bottom when the page is oriented in a landscape orientation. This row and column convention holds true for the reports illustrated in FIGS. 7-12 as well. In FIG. 6, each of the rows corresponds to a different incident associated with the vendor. Example incidents may include recalls, market withdrawals, and track-and-trend events. Each of the columns corresponds to a different type of information regarding an incident associated with the vendor. In the example of FIG. 6, a first column corresponds to an identifier of a merchandise type associated with an incident this year. This first column may include the unique identifiers, e.g. stock-keeping unit (SKU) numbers associated with the merchandise type to which the vendor incident is related. A second column corresponds to a description of a type of merchandise associated with the incident. A third column corresponds to a brand name of the type of merchandise associated with the incident. A fourth column corresponds to an identified hazard associated with the type of merchandise associated with the incident. A fifth column corresponds to an action (e.g., recall, market withdrawal, track-and-trend, etc.) associated with the incident. A sixth column corresponds to a date on which the action associated with the incident was performed. A seventh column corresponds to an investigation number associated with the incident. An eighth column corresponds to a name of a factory associated with the incident. The factory associated with the incident may be a factory at which items or components of item belonging to a merchandise type associated with the incident were manufactured. A ninth column corresponds to an identifier of the factory associated with the incident. A tenth column corresponds to names of vendors using the factory associated with the incident. An eleventh column corresponds to a current factory scorecard status for the factory associated with the incident. The current factory scorecard status for the factory may indicate the retailer's evaluation of the factory's performance with regard to recalls or market withdrawals.

FIG. 7 is a conceptual diagram that illustrates an example vendors-by-division report 350 generated by recall system 10. The retailer may use the vendors-by-division report 350 to analyze the performance of vendors associated with particular divisions of the retailer.

Vendor-by-division report 350 includes a set of rows and a set of columns. Each of the rows corresponds to a different vendor. Each of the columns corresponds to a different type of information associated with a vendor. In the example of FIG. 7, a first column corresponds to a name of the vendor. A second column corresponds to a status of the vendor. A third column corresponds to a department of the retailer associated with the vendor. A fourth column corresponds to a number of recalls associated with the vendor this year. A fifth column corresponds to a number of recalls associated with the vendor last year. A sixth column corresponds to a number of market withdrawals associated with the vendor this year. A seventh column corresponds to a number of market withdrawals associated with the vendor last year. An eighth column corresponds to a total number of track-and-trend incidents associated with the vendor this year. A ninth column corresponds to a total number of track-and-trend incidents associated with the vendor last year. A tenth column corresponds to an assessment of the vendor. The assessment of the vendor may indicate the retailer's assessment of the vendor's performance with regard to recalls and product withdrawals.

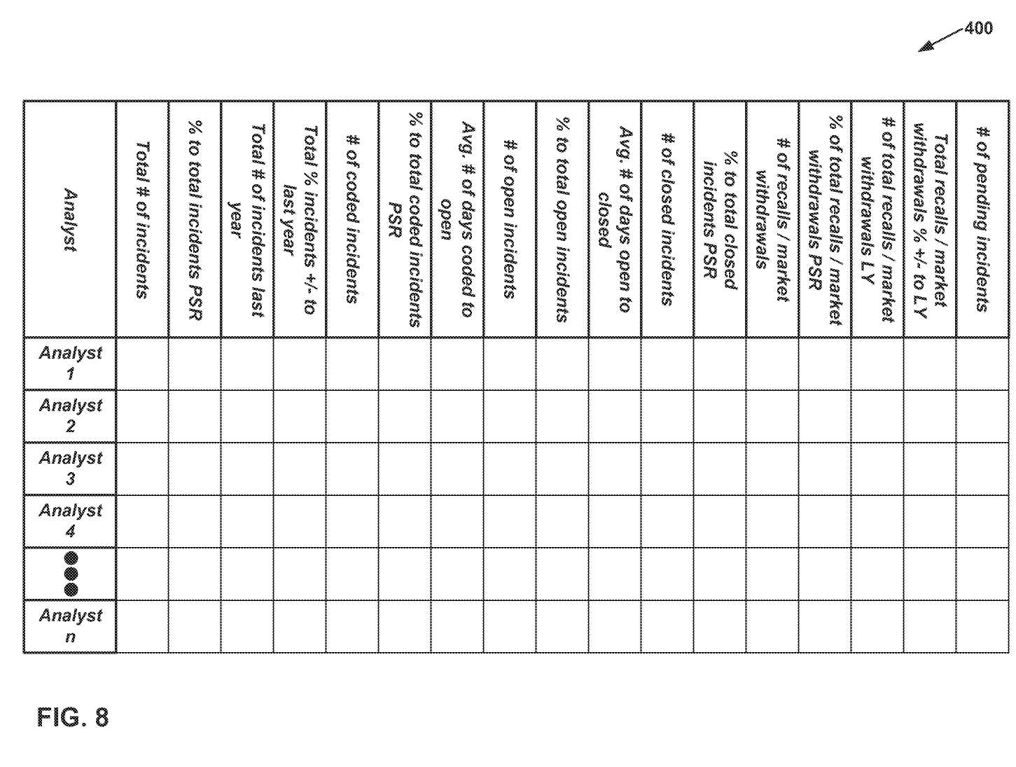

FIG. 8 is a conceptual diagram that illustrates an example analyst summary report 400 generated by recall system 10. The retailer may use analyst summary report 400 to analyze the performance of analysts. An analyst may be a person who analyzes data to determine whether the retailer should perform a recall, a market withdrawal, or a track-and-trend process for a merchandise type.

Analyst summary report 400 includes a set of rows and a set of columns. Each of the rows corresponds to a different analyst. Each of the columns corresponds to a different type of information associated with an analyst. In the example of FIG. 8, a first column corresponds to a name of the analyst. A second column corresponds to a total number of incidents associated with the analyst. A third column corresponds to a percentage of the total number of incidents that are associated with the analyst. A fourth column corresponds to a total number of incidents associated with the analyst last year. A fifth column corresponds to a percentage change in the number of incidents associated with the analyst from last year to this year. A sixth column corresponds to a total number of coded incidents associated with the analyst. An incident may be coded when a person associated with the retailer has reviewed contact information for a customer who has complained about the merchandise type and assigned a severity level to the complaint. A seventh column corresponds to a percentage of the total number of coded incidents that are associated with the analyst. An eighth column corresponds to an average number of days for the analyst to move an incident from coded to open. An incident may be opened when an analyst opens an investigation of a complaint. A ninth column corresponds to a number of open incidents associated with the analyst. A tenth column corresponds to a percentage of the total number of open incidents that are associated with the analyst. An eleventh column corresponds to an average number of days for the analyst to move an incident from open to closed. A twelfth column corresponds to a number of closed incidents associated with the analyst. A thirteen column corresponds to a percentage of the total number of closed incidents associated with the analyst. A fourteenth column corresponds to a total number of recalls and market withdrawals associated with the analyst. A fifteenth column corresponds to a percentage of the total number of recalls and market withdrawals that are associated with the analyst. A sixteenth column corresponds to a total number of recalls and market withdrawals associated with the analyst last year. A seventeen column corresponds to a percentage change in the number of recalls and market withdrawals associated with the analyst from last year to this year. An eighteenth column corresponds to a number of pending incidents associated with the analyst.

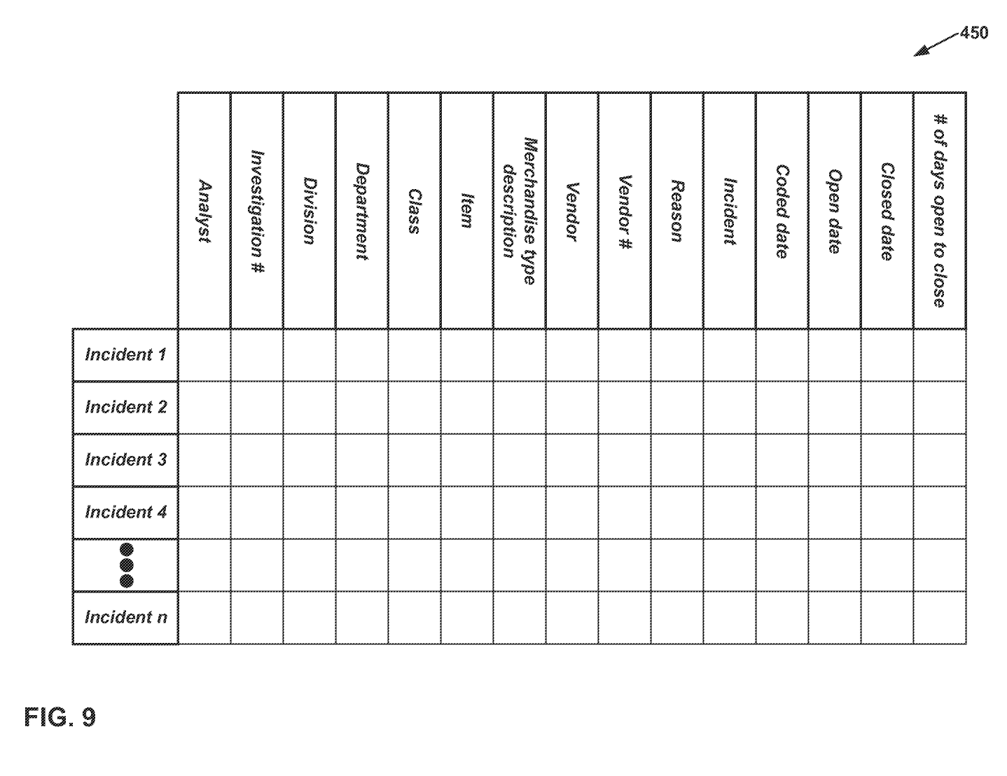

FIG. 9 is a conceptual diagram that illustrates an example analyst detail report 450 generated by recall system 10. The retailer may use analyst detail report 450 to analyze the incidents associated with a particular analyst.

Analyst detail report 450 includes a set of rows and a set of columns. Each of the rows corresponds to a different incident associated with the analyst. Each of the columns corresponds to a different type of information associated with an incident. In the example of FIG. 9, a first column corresponds to a name of the analyst. A second column corresponds to an identifier of a recall investigation associated with the incident. A third column corresponds to a division of the retailer associated with the incident. A fourth column corresponds to a department of the retailer associated with the incident. A fifth column corresponds to a class of the merchandise type associated with the incident. A sixth column corresponds to an item identifier for the merchandise type associated with the incident. A seventh column corresponds to a description of the merchandise type associated with the incident. An eighth column corresponds to a name of a vendor of the merchandise type associated with the incident. A ninth column corresponds to an identifier of the vendor of the merchandise type associated with the incident. A tenth column corresponds to a general reason why the merchandise type is being removed from sale. An eleventh column corresponds to a specific description of the reason for the incident. A twelfth column corresponds to a coded date associated with the incident. A thirteenth column corresponds to a date on which the incident was opened. A fourteenth column corresponds to a date on which the incident was closed. A fourteenth column corresponds to a number of days from when the incident was opened to closed.

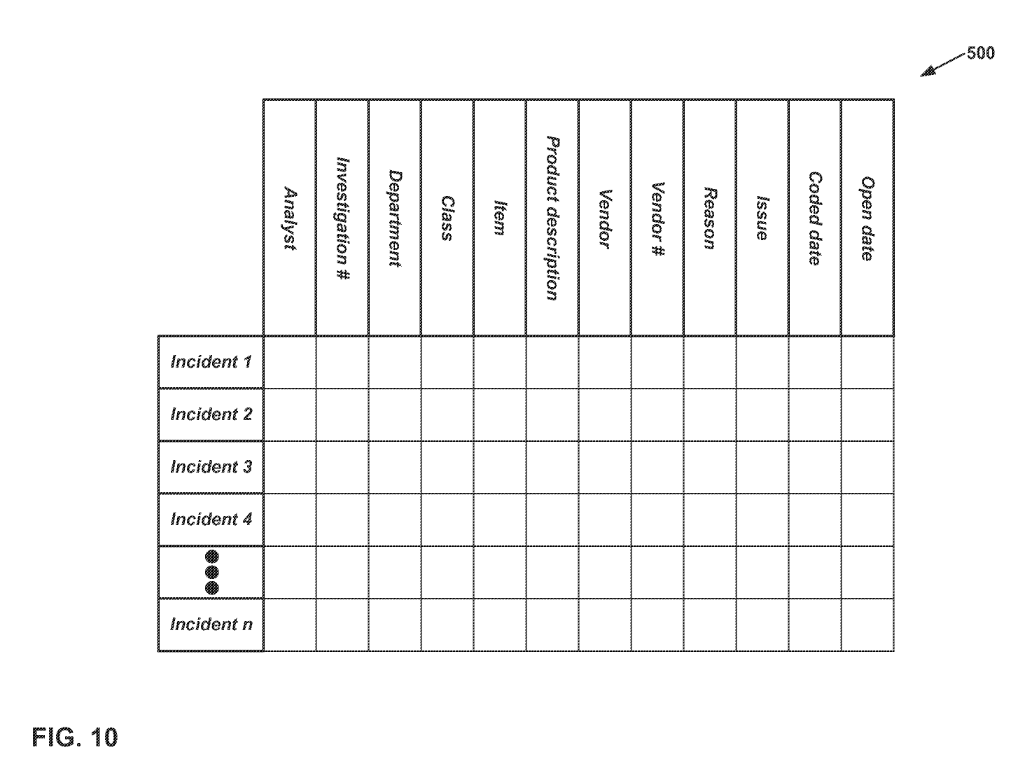

FIG. 10 is a conceptual diagram that illustrates an example analyst pending incidents report 500 generated by recall system 10. The retailer may use analyst pending incidents report 500 to analyze the pending incidents associated with an analyst.

Analyst pending incidents report 500 includes a set of rows and a set of columns. Each of the rows corresponds to a different pending incident associated with a particular analyst. Each of the columns corresponds to a different type of information associated with a pending incident associated with the analyst. In the example of FIG. 10, a first column corresponds to a name of the analyst. A second column corresponds to an investigation number associated with the incident. A third column corresponds to a department identifier for a department of the retailer associated with incident. A fourth column corresponds to a class of the type of merchandise associated with the incident. A fifth column corresponds to an item identifier of the type of merchandise associated with the incident. A sixth column corresponds to a description of the type of merchandise associated with the incident. A seventh column corresponds to a name of a vendor of the type of merchandise associated with the incident. An eighth column corresponds to a vendor identifier of the vendor of the type of merchandise associated with the incident. A ninth column corresponds to a general description of the reason for the incident. A tenth column corresponds to a specific description of the reason for the incident. An eleventh column corresponds to a coded date for the incident. A twelfth column corresponds to an open date for the incident.

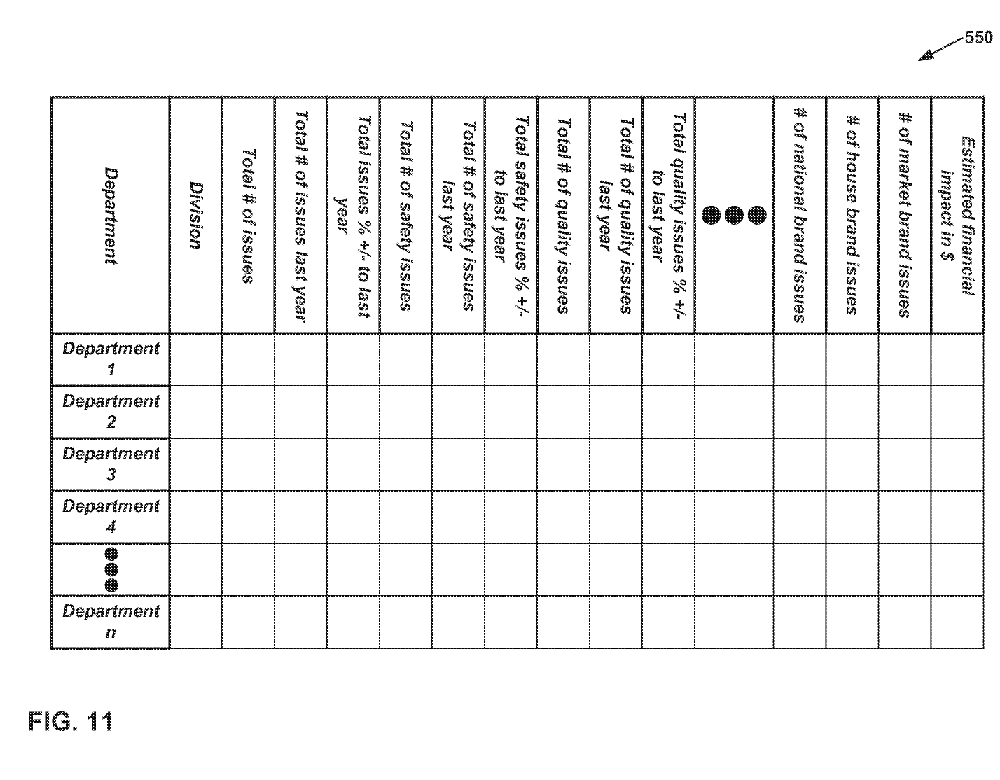

FIG. 11 is a conceptual diagram that illustrates an example product detail report 550 generated by recall system 10. The retailer may use product detail report 550 to analyze incidents associated with different departments of the retailer. Each department of the retailer may be responsible for selling particular types of merchandise. For example, one department of the retailer may be responsible for selling televisions while another department of the retailer may be responsible for selling video games. In this example, both of these departments may be in an “electronics” division of the retailer.

Product detail report 550 includes a set of rows and a set of columns. Each of the rows corresponds to a different department of the retailer. Each of the columns corresponds to a different type of information associated with a department. In the example of FIG. 11, a first column corresponds to a division identifier for the department. A second column corresponds to a department identifier for the department. A third column corresponds to a total number of incidents associated with the department. A fourth column corresponds to a total number of incidents associated with the department this year. A fifth column corresponds to a percent change in the total number of incidents associated with the department from last year to this year. A sixth column corresponds to a total number of safety related incidents associated with the department this year. A seventh column corresponds to a total number of safety related incidents associated with the department last year. An eighth column corresponds to a percent change in the total number of safety related incidents from last year to this year. A ninth column corresponds to a total number of quality related incidents associated with the department this year. A tenth column corresponds to a total number of quality related incidents associated with the department last year. An eleventh column corresponds to a percent change in the total number of quality related incidents from last year to this year. A twelfth column corresponds to the number of incidents associated with national brands sold by the department. A national brand may be a brand of merchandise sold by the retailer nationwide under a third-party brand. A thirteenth column corresponds to the number of incidents associated with house brands sold by the department. A house brand may be a brand of merchandise sold by the retailer nationwide under the retailer's own brand. A fourteenth column corresponds to the number of incidents associated with market brands sold by the department. Market brands may be brands of merchandise sold by the retailer is particular geographical markets. A fifteenth column corresponds to an estimated financial impact of incidents associated with the department.

As illustrated by the ellipses in FIG. 11, product detail report 550 may include additional columns. Such additional columns may correspond to total numbers of intellectual property related incidents this year, total numbers of intellectual property related incidents last year, percent changes in intellectual property related incidents from last year to this year, total numbers of regulatory related incidents this year, total numbers of regulatory related incidents last year, percent changes in regulatory related incidents from last year to this year, total numbers of offensive material related incidents this year, total numbers of offensive material related incidents last year, percent changes in offensive material related incidents from last year to this year, and so on.

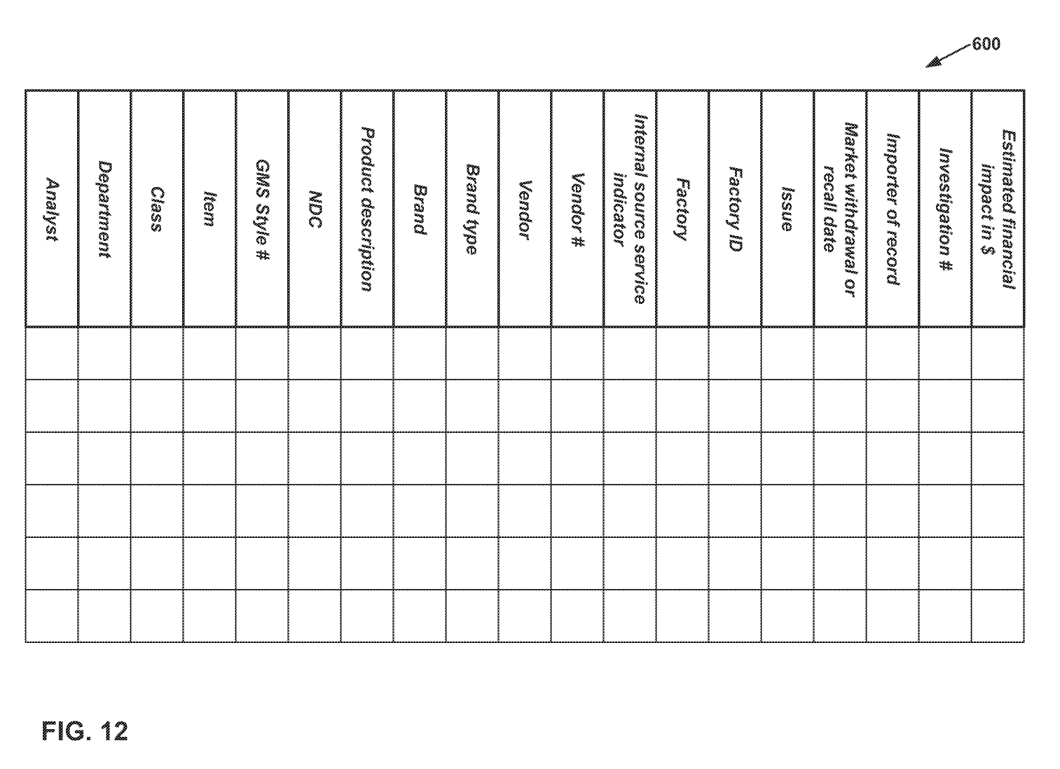

FIG. 12 is a conceptual diagram that illustrates an example product detail by division report 600 generated by recall system 10. The retailer may use product detail by division report 600 to analyze incidents regarding types of merchandise associated with a particular division of the retailer. For example, the retailer may have several divisions, each responsible for selling a different general type of merchandise. In this example, the retailer may use product detail by division report 600 to analyze recall investigations regarding a healthcare division of the retailer.

Product detail by division report 600 includes a set of rows and a set of columns. Each of the rows corresponds to a recall investigation regarding a type of merchandise associated with the particular division of the retailer. Each of the columns corresponds to a different type of information associated with a recall investigation. In the example of FIG. 12, a first column corresponds to an analyst name. A second column corresponds to a department identifier. A third column corresponds to an item class identifier. A fourth column corresponds to an item identifier. In some examples, the item identifier may be based on a national drug code (NDC) from a RMIS and an associated identifier for a merchandise type (e.g., a Department Class and Item Number (DPCI)) from a GMS item. A fifth column corresponds to a global merchandising system (GMS) style number. A sixth column corresponds to a NDC. A seventh column corresponds to a product description. An eighth column corresponds to a brand identifier. A ninth column corresponds to a brand type identifier. A tenth column corresponds to a vendor name. An eleventh column corresponds to a vendor identifier. A twelfth column corresponds to an internal sourcing service indicator that indicates whether the merchandise is sourced through an internal sourcing service. A thirteenth column corresponds to a factory name. A fourteenth column corresponds to a factory identifier. A fifteenth column corresponds to an incident description. A sixteenth column corresponds to a date of market withdrawal or recall. A seventeenth column corresponds to an importer of record. The importer of record may be an entity responsible for ensuring that imported goods comply with local laws and regulations, filing a completed duty entry and associated documents, and paying the assessed import duties and other taxes on those goods. An eighteenth column corresponds to an investigation number. A nineteenth column corresponds to an estimated financial impact of performing a recall or market withdrawal of the type of merchandise associated with the recall investigation. In other examples, product detail by division report 600 may include additional columns. Such additional columns may correspond to an online item identifier, country of origin, a product removal date, a reason for market withdrawal or recall, and/or other information.

FIG. 13 is a block diagram of an example configuration of a computer system 700. In the example of FIG. 13, computer system 700 comprises a computing device 702 and one or more other computing devices. Computer system 700 or similar computing systems may implement recall system 10, client system 12, inventory management system 14, and/or data sources 18.

Computing device 702 is a physical device that processes information. In the example of FIG. 13, computing device 702 comprises a data storage system 702, a memory 704, a secondary storage system 706, a processing system 708, an input interface 710, a display interface 712, a communication interface 714, and one or more communication media 716. Communication media 716 enable data communication between processing system 708, input interface 710, display interface 712, communication interface 714, memory 704, and secondary storage system 706. Computing device 702 can include components in addition to those shown in the example of FIG. 13. Furthermore, some computing devices do not include all of the components shown in the example of FIG. 13.

A computer-readable medium may be a medium from which a processing system can read data. Computer-readable media may include computer storage media and communications media. Computer storage media may include physical devices that store data for subsequent retrieval. Computer storage media are not transitory. For instance, computer storage media do not exclusively comprise propagated signals. Computer storage media may include volatile storage media and non-volatile storage media. Example types of computer storage media may include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media may include media over which one device can communicate data to another device. Example types of communication media may include communication networks, communications cables, wireless communication links, communication buses, and other media over which one device is able to communicate data to another device.

Data storage system 702 may be a system that stores data for subsequent retrieval. In the example of FIG. 13, data storage system 702 comprises memory 704 and secondary storage system 706. Memory 704 and secondary storage system 706 may store data for later retrieval. In the example of FIG. 13, memory 704 stores computer-executable instructions 718 and program data 720. Secondary storage system 706 stores computer-executable instructions 722 and program data 724. Physically, memory 704 and secondary storage system 706 may each comprise one or more computer storage media.

Processing system 708 is coupled to data storage system 702. Processing system 708 may read computer-executable instructions from data storage system 702 and executes the computer-executable instructions. Execution of the computer-executable instructions by processing system 708 may configure and/or cause computing device 702 to perform the actions indicated by the computer-executable instructions. For example, execution of the computer-executable instructions by processing system 708 can configure and/or cause computing device 702 to provide Basic Input/Output Systems, operating systems, system programs, application programs, or can configure and/or cause computing device 702 to provide other functionality.

Processing system 708 may read the computer-executable instructions from one or more computer-readable media. For example, processing system 708 may read and execute computer-executable instructions 718 and 722 stored on memory 704 and secondary storage system 706.

Processing system 708 may comprise one or more processing units 726. Processing units 726 may comprise physical devices that execute computer-executable instructions. Processing units 726 may comprise various types of physical devices that execute computer-executable instructions. For example, one or more of processing units 726 may comprise a microprocessor, a processing core within a microprocessor, a digital signal processor, a graphics processing unit, or another type of physical device that executes computer-executable instructions.

Input interface 710 may enable computing device 702 to receive input from an input device 728. Input device 728 may comprise a device that receives input from a user. Input device 728 may comprise various types of devices that receive input from users. For example, input device 728 may comprise a keyboard, a touch screen, a mouse, a microphone, a keypad, a joystick, a brain-computer interface device, or another type of device that receives input from a user. In some examples, input device 728 is integrated into a housing of computing device 702. In other examples, input device 728 is outside a housing of computing device 702. In some examples, input device 728 may receive report requests, inventory data, and/or other types of data as described above.

Display interface 712 may enable computing device 702 to display output on a display device 730. Display device 730 may be a device that displays output. Example types of display devices include monitors, touch screens, display screens, televisions, and other types of devices that display output. In some examples, display device 730 is integrated into a housing of computing device 702. In other examples, display device 730 is outside a housing of computing device 702. In some examples, display device 730 may display reports or other types of data as described above.

Communication interface 714 may enable computing device 702 to send and receive data over one or more communication media. Communication interface 714 may comprise various types of devices. For example, communication interface 714 may comprise a Network Interface Card (NIC), a wireless network adapter, a Universal Serial Bus (USB) port, or another type of device that enables computing device 702 to send and receive data over one or more communication media. In some examples, communication interface 714 may receive configuration data, trial data, and/or other types of data as described above. Furthermore, in some examples, communication interface 714 may output alerts, queries, and/or other types of data as described above.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various examples have been described. These examples and others are within the scope of the following claims.

1. A method for facilitating analysis of recalls and market withdrawals, the method comprising:
obtaining, by a computer system on a recurring basis, sets of inventory data from an inventory management system, the sets of inventory data associated with monetary values of a merchandise type in an inventory of a retailer at different times;
storing, by the computer system, the sets of inventory data in a database separate from the inventory management system;
determining, by the computer system based at least in part on the sets of inventory data stored in the database, an estimated financial impact to the retailer of performing a recall or market withdrawal of the merchandise type; and
outputting, by the computer system, a report that indicates the estimated financial impact.

2. The method of claim 1, wherein the recurring basis is a first recurring basis and inventory data within the inventory management system updates on a second recurring basis, the second recurring basis being more frequent than the first recurring basis.

3. The method of claim 2,
wherein obtaining the sets of inventory data from the inventory management system comprises obtaining a set of inventory data from the inventory management system once per day, and
wherein the inventory data in the inventory management system updates at least once per hour.

4. The method of claim 1,
wherein the method further comprises:
determining, by the computer system, an ending-on-hand value for the merchandise type based on the inventory data stored in the database, the ending-on-hand value indicating a monetary value of the retailer's inventory of items of the merchandise type at an end of a period;
determining, by the computer system, an on-order value for the merchandise type based on the inventory data stored in the database, the on-order value for the merchandise type indicating the monetary value of items belonging to the merchandise type that the retailer has ordered from a vendor of the merchandise type, but has not yet received;
determining, by the computer system, an owned-on-order value for the merchandise type based on the inventory data stored in the database, the owned-on-order value for the merchandise type indicating a monetary value of items belonging to the merchandise type that are owned by the retailer and are in transit between two facilities for replenishment of one of the facilities; and
determining, by the computer system, an on-withdrawal value for the merchandise type based on the inventory data stored in the database, the on-withdrawal value for the merchandise type indicating the monetary value of items belonging to the merchandise type that are en route from a distribution center of the retailer to a store of the retailer; and
wherein determining the estimated financial impact comprises determining the estimated financial impact based on the ending-on-hand value for the merchandise type, the on-order value for the merchandise type, the owned-on-order value for the merchandise type, and the on-withdrawal value for the merchandise type.

5. The method of claim 4, wherein determining the ending-on-hand value for the merchandise type comprises determining, by the computer system, the ending-on-hand value for the merchandise type based on a beginning-on-hand value for the merchandise type, a total receipts value for the merchandise type, a total sales value for the merchandise type, a shortage value for the merchandise type, an employee discount value for the merchandise type, a total markdown value for the merchandise type, and a return-to-vendor value for the merchandise type,
wherein the beginning-on-hand value for the merchandise type indicates a monetary value of items belonging to the merchandise type at a beginning of the period,
wherein the total sales value for the merchandise type indicates a monetary value of items belonging to the merchandise type that the retailer sold during the period,
wherein the total receipts value for the merchandise type indicates a monetary value of items of the merchandise type that have been received by the retailer,
wherein the shortage value for the merchandise type indicates a monetary value of items belonging to the merchandise type lost or stolen during the period,
wherein the employee discount value of the merchandise type indicates a monetary value of employee discounts associated with sales of the merchandise type,
wherein the total markdown value of the merchandise type indicates a total monetary value of markdowns associated with sales of the merchandise type, and
wherein the return-to-vendor value of the merchandise type indicates a monetary value of items belonging to the merchandise type returned to the vendor of the merchandise type during the period.

6. The method of claim 1, further comprising purging, by the computer system, expired sets of inventory data from the database, the expired sets of inventory data having been stored in the database for longer than an expiration period.

7. The method of claim 1, further comprising:
obtaining, by the computer system, additional data from a data source separate from the inventory management system; and
generating, by the computer system, the report based on the estimated financial impact and the additional data.

8. The method of claim 7, further comprising associating the additional data with the estimated financial impact.

9. The method of claim 8, wherein the additional data comprises data related to a vendor that supplies the merchandise type to the retailer.

10. The method of claim 9, wherein the report indicates recalls or market withdrawals of merchandise types associated with estimated financial impacts of the merchandise types and vendors that supply the merchandise types to the retailer.

11. The method of claim 1, wherein the report indicates recalls or market withdrawals of merchandise types associated with a division or department of the retailer.

12. The method of claim 1, wherein the report indicates recalls or market withdrawals associated with an analyst associated with the retailer.

13. The method of claim 1, further comprising generating the report such that the report includes a table that indicates the estimated financial impact.

14. A computer system that comprises:
one or more computer-readable storage media; and
one or more processors coupled to the one or more computer-readable storage media, execution by the one or more processors of instructions stored on the one or more computer-readable storage media causing the computer system to:
obtain, on a recurring basis, sets of inventory data from an inventory management system, the sets of inventory data associated with monetary values of a merchandise type in an inventory of a retailer at different times;
store the sets of inventory data in a database separate from the inventory management system;
determine, based at least in part on the sets of inventory data stored in the database, an estimated financial impact to the retailer of performing a recalling or market withdrawal of the merchandise type; and
output a report that indicates the estimated financial impact.

15. The computer system of claim 14, wherein the recurring basis is a first recurring basis and inventory data within the inventory management system updates on a second recurring basis, the second recurring basis being more frequent than the first recurring basis.

16. The computer system of claim 14, wherein execution of the instructions further causes the computer system to:
determine an ending-on-hand value for the merchandise type based on the inventory data stored in the database, the ending-on-hand value indicating a monetary value of the retailer's inventory of items of the merchandise type at an end of a period;
determine an on-order value for the merchandise type based on the inventory data stored in the database, the on-order value for the merchandise type indicating the monetary value of items belonging to the merchandise type that the retailer has ordered from a vendor of the merchandise type, but has not yet received;
determine an owned-on-order value for the merchandise type based on the inventory data stored in the database, the owned-on-order value for the merchandise type indicating a monetary value of items belonging to the merchandise type that are owned by the retailer and are in transit between two facilities for replenishment of one of the facilities;
determine an on-withdrawal value for the merchandise type based on the inventory data stored in the database, the on-withdrawal value for the merchandise type indicating the monetary value of items belonging to the merchandise type that are en route from a distribution center of the retailer to a store of the retailer; and
determine the estimated financial impact based on the ending-on-hand value for the merchandise type, the on-order value for the merchandise type, the owned-on-order value for the merchandise type, and the on-withdrawal value for the merchandise type.

17. The computer system of claim 16, wherein the instructions cause the computer system to determine the ending-on-hand value for the merchandise type based on a beginning-on-hand value for the merchandise type, a total receipts value for the merchandise type, a total sales value for the merchandise type, a shortage value for the merchandise type, an employee discount value for the merchandise type, a total markdown value for the merchandise type, and a return-to-vendor value for the merchandise type,
wherein the beginning-on-hand value for the merchandise type indicates a monetary value of items belonging to the merchandise type at a beginning of the period,
wherein the total sales value for the merchandise type indicates a monetary value of items belonging to the merchandise type that the retailer sold during the period,
wherein the total receipts value for the merchandise type indicates a monetary value of items of the merchandise type that have been received by the retailer,
wherein the shortage value for the merchandise type indicates a monetary value of items belonging to the merchandise type lost or stolen during the period,
wherein the employee discount value of the merchandise type indicates a monetary value of employee discounts associated with sales of the merchandise type,
wherein the total markdown value of the merchandise type indicates a total monetary value of markdowns associated with sales of the merchandise type, and
wherein the return-to-vendor value of the merchandise type indicates a monetary value of items belonging to the merchandise type returned to the vendor of the merchandise type during the period.

18. The computer system of claim 14, wherein the instructions cause the computer system to purge expired sets of inventory data from the database, the expired sets of inventory data having been stored in the database for longer than an expiration period.

19. The computer system of claim 14, wherein the instructions cause the computer system to:
obtain additional data from a data source separate from the inventory management system; and
generate the report based on the estimated financial impact and the additional data.

20. The computer system of claim 19, wherein the instructions cause the computer system to associate the additional data with the estimated financial impact.

21. The computer system of claim 20, wherein the additional data comprises data related to a vendor that supplies the merchandise type to the retailer.

22. The computer system of claim 21, wherein the report indicates recalls or market withdrawals of merchandise types associated with estimated financial impacts of the merchandise types and vendors that supply the merchandise types to the retailer.

23. The computer system of claim 14, wherein the report indicates recalls or market withdrawals of merchandise types associated with a division or department of the retailer.

24. A computer program product that comprises one or more computer-readable storage media that store instructions that, when executed by one or more processors, cause a computer system to:
obtain, on a recurring basis, sets of inventory data from an inventory management system, the sets of inventory data associated with monetary values of a merchandise type in an inventory of a retailer at different times;
store the sets of inventory data in a database separate from the inventory management system;
determine, based at least in part on the sets of inventory data stored in the database, an estimated financial impact to the retailer of performing a recall or market withdrawal of the merchandise type; and
output a report that indicates the estimated financial impact.
